(19) United States
(12) Patent Application Publication
(10) Pub. No.: US 2024/0185390 A1
(43) Pub. Date: Jun. 6, 2024

(54) FUSION OF IMAGE FRAMES FOR HIGH DYNAMIC RANGE CONTENT

(71) Applicant: QUALCOMM Incorporated, San Diego, CA (US)

(72) Inventors: Xiaoyun Jiang, San Diego, CA (US); Nyeongkyu Kwon, San Diego, CA (US)

(21) Appl. No.: 18/061,856

(22) Filed: Dec. 5, 2022

(51) Int. Cl. G06T 5/50; G06T 5/00; G06T 5/20; G06T 7/20

(52) U.S. Cl. CPC G06T 5/50; G06T 5/003; G06T 5/009; G06T 5/20; G06T 7/20; G06T 2207/10016; G06T 2207/10144; G06T 2207/20201; G06T 2207/20208; G06T 2207/20221

(57) ABSTRACT

This disclosure provides systems, methods, and devices for image signal processing detect and correct motion during HDR fusion. In a first aspect, a method is provided that includes receiving a first image frame, a second image frame, and a third image frame. The second image frame may be captured with a short exposure time and the third image frame may be captured with a long exposure time. The method may include determining a first motion map based on the first and third image frames and a second motion map based on the second and third image frames. A third motion map may be determined based on the first and second motion maps and used to determine a fourth image frame by combining the second and third image frames. Other aspects and features are also claimed and described.

### TECHNICAL FIELD

Aspects of the present disclosure relate generally to image processing, and more particularly, to high-dynamic range images. Some features may enable and provide improved image processing, including improved techniques for detecting and correcting movement in image frames fused to form high dynamic range content.

### INTRODUCTION

Image capture devices are devices that can capture one or more digital images, whether still images for photos or sequences of images for videos. Capture devices can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

Dynamic range may be important to image quality when capturing a representation of a scene with a wide color gamut using an image capture device. Conventional image sensors have a limited dynamic range, which may be smaller than the dynamic range of human eyes. Dynamic range may refer to the light range between bright portions of an image and dark portions of an image. A conventional image sensor may increase an exposure time to improve detail in dark portions of an image at the expense of saturating bright portions of an image. Alternatively, a conventional image sensor may decrease an exposure time to improve detail in bright portions of an image at the expense of losing detail in dark portions of the image. Thus, image capture devices conventionally balance conflicting desires, preserving detail in bright portions or dark portions of an image, by adjusting exposure time. High dynamic range (HDR) photography improves photography using these conventional image sensors by combining multiple recorded representations of a scene from the image sensor.

Movement of subjects while capturing image frames (i.e., image frames for composition into a single still image, image frames for use as part of a video sequence) can create various distortions within the image frames. For example, movement of one or more objects within an image frame may cause the objects to blur and/or blend together or may leave motion artifacts within the captured image frame.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In some aspects, HDR processing of received image frames may be performed based on multiple motion maps determined for different sets of image frames. A first motion map may be determined based on a previous reference frame and a current image frame with a long exposure time. A second motion map may be determined based on a current image frame with a short exposure time and the current image frame with a long exposure time. The first and second motion maps may then be combined to form a third motion map that excludes noise-induced motion regions within first and second motion maps. The current image frames may then be blended based on the third motion map to generate a fourth image frame (such as an HDR image frame for the current image frames). In certain instances, the improved, third motion map may also be used to apply a TF process and generate a fifth image frame to correct for motion between a previous reference image frame and the fourth image frame.

In some aspects, the techniques described herein relate to an apparatus, including: a memory storing processor-readable code; and at least one processor coupled to the memory, the at least one processor configured to execute the processor-readable code to cause the at least one processor to perform operations including: receiving a first image frame, a second image frame, and a third image frame, wherein the second image frame is captured with a first exposure time and the third image frame is captured with a second exposure time longer than the first exposure time; determining a first motion map based on the first image frame and the third image frame; determining a second motion map based on the second image frame and the third image frame; determining a third motion map based on the first motion map and the second motion map; and determining a fourth image frame by combining the second image frame and the third image frame according to the third motion map.

In some aspects, the techniques described herein relate to a method, including: receiving a first image frame, a second image frame, and a third image frame, wherein the second image frame is captured with a first exposure time and the third image frame is captured with a second exposure time longer than the first exposure time; determining a first motion map based on the first image frame and the third image frame; determining a second motion map based on the second image frame and the third image frame; determining a third motion map based on the first motion map and the second motion map; and determining a fourth image frame by combining the second image frame and the third image frame according to the third motion map.

In some aspects, the techniques described herein relate to a non-transitory, computer-readable medium storing instructions that, when executed by a processor, cause the processor to perform operations including: receiving a first image frame, a second image frame, and a third image frame, wherein the second image frame is captured with a first exposure time and the third image frame is captured with a second exposure time longer than the first exposure time; determining a first motion map based on the first image frame and the third image frame; determining a second motion map based on the second image frame and the third image frame; determining a third motion map based on the first motion map and the second motion map; and determining a fourth image frame by combining the second image frame and the third image frame according to the third motion map.

In some aspects, the techniques described herein relate to an image capture device, including: an image sensor; a memory storing processor-readable code; and at least one processor coupled to the memory and to the image sensor, the at least one processor configured to execute the processor-readable code to cause the at least one processor to: receive a first image frame, a second image frame, and a third image frame, wherein the second image frame is captured with a first exposure time and the third image frame is captured with a second exposure time longer than the first exposure time; determine a first motion map based on the first image frame and the third image frame; determine a second motion map based on the second image frame and the third image frame; determine a third motion map based on the first motion map and the second motion map; and determine a fourth image frame by combining the second image frame and the third image frame according to the third motion map.

Methods of image processing described herein may be performed by an image capture device and/or performed on image data captured by one or more image capture devices. Image capture devices, devices that can capture one or more digital images, whether still image photos or sequences of images for videos, can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

The image processing techniques described herein may involve digital cameras having image sensors and processing circuitry (e.g., application specific integrated circuits (ASICs), digital signal processors (DSP), graphics processing unit (GPU), or central processing units (CPU)). An image signal processor (ISP) may include one or more of these processing circuits and configured to perform operations to obtain the image data for processing according to the image processing techniques described herein and/or involved in the image processing techniques described herein. The ISP may be configured to control the capture of image frames from one or more image sensors and determine one or more image frames from the one or more image sensors to generate a view of a scene in an output image frame. The output image frame may be part of a sequence of image frames forming a video sequence. The video sequence may include other image frames received from the image sensor or other images sensors.

In an example application, the image signal processor (ISP) may receive an instruction to capture a sequence of image frames in response to the loading of software, such as a camera application, to produce a preview display from the image capture device. The image signal processor may be configured to produce a single flow of output image frames, based on images frames received from one or more image sensors. The single flow of output image frames may include raw image data from an image sensor, binned image data from an image sensor, or corrected image data processed by one or more algorithms within the image signal processor. For example, an image frame obtained from an image sensor, which may have performed some processing on the data before output to the image signal processor, may be processed in the image signal processor by processing the image frame through an image post-processing engine (IPE) and/or other image processing circuitry for performing one or more of tone mapping, portrait lighting, contrast enhancement, gamma correction, etc. The output image frame from the ISP may be stored in memory and retrieved by an application processor executing the camera application, which may perform further processing on the output image frame to adjust an appearance of the output image frame and reproduce the output image frame on a display for view by the user.

After an output image frame representing the scene is determined by the image signal processor and/or determined by the application processor, such as through image processing techniques described in various embodiments herein, the output image frame may be displayed on a device display as a single still image and/or as part of a video sequence, saved to a storage device as a picture or a video sequence, transmitted over a network, and/or printed to an output medium. For example, the image signal processor (ISP) may be configured to obtain input frames of image data (e.g., pixel values) from the one or more image sensors, and in turn, produce corresponding output image frames (e.g., preview display frames, still-image captures, frames for video, frames for object tracking, etc.). In other examples, the image signal processor may output image frames to various output devices and/or camera modules for further processing, such as for 3A parameter synchronization (e.g., automatic focus (AF), automatic white balance (AWB), and automatic exposure control (AEC)), producing a video file via the output frames, configuring frames for display, configuring frames for storage, transmitting the frames through a network connection, etc. Generally, the image signal processor (ISP) may obtain incoming frames from one or more image sensors and produce and output a flow of output frames to various output destinations.

In some aspects, the output image frame may be produced by combining aspects of the image correction of this disclosure with other computational photography techniques such as high dynamic range (HDR) photography or multi-frame noise reduction (MFNR). With HDR photography, a first image frame and a second image frame are captured using different exposure times, different apertures, different lenses, and/or other characteristics that may result in improved dynamic range of a fused image when the two image frames are combined. In some aspects, the method may be performed for MFNR photography in which the first image frame and a second image frame are captured using the same or different exposure times and fused to generate a corrected first image frame with reduced noise compared to the captured first image frame.

In some aspects, a device may include an image signal processor or a processor (e.g., an application processor) including specific functionality for camera controls and/or processing, such as enabling or disabling the binning module or otherwise controlling aspects of the image correction. The methods and techniques described herein may be entirely performed by the image signal processor or a processor, or various operations may be split between the image signal processor and a processor, and in some aspects split across additional processors.

The device may include one, two, or more image sensors, such as a first image sensor. When multiple image sensors are present, the image sensors may be differently configured. For example, the first image sensor may have a larger field of view (FOV) than the second image sensor, or the first image sensor may have different sensitivity or different dynamic range than the second image sensor. In one example, the first image sensor may be a wide-angle image sensor, and the second image sensor may be a tele image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. Any of these or other configurations may be part of a lens cluster on a mobile device, such as where multiple image sensors and associated lenses are located in offset locations on a frontside or a backside of the mobile device. Additional image sensors may be included with larger, smaller, or same field of views. The image processing techniques described herein may be applied to image frames captured from any of the image sensors in a multi-sensor device.

In an additional aspect of the disclosure, a device configured for image processing and/or image capture is disclosed. The apparatus includes means for capturing image frames. The apparatus further includes one or more means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors) and time of flight detectors. The apparatus may further include one or more means for accumulating and/or focusing light rays into the one or more image sensors (including simple lenses, compound lenses, spherical lenses, and non-spherical lenses). These components may be controlled to capture the first and/or second image frames input to the image processing techniques described herein.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a processor to perform the steps of the method. In some embodiments, the processor may be part of a mobile device including a first network adaptor configured to transmit data, such as images or videos in a recording or as streaming data, over a first network connection of a plurality of network connections; and a processor coupled to the first network adaptor and the memory. The processor may cause the transmission of output image frames described herein over a wireless communications network such as a 5G NR communication network.

The foregoing has outlined, rather broadly, the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of an example device for performing image capture from one or more image sensors.

FIG. 2 is a block diagram illustrating an example data flow path for image data processing in an image capture device according to one or more embodiments of the disclosure.

FIG. 3A depicts a system for correcting for movement in HDR image frame fusion according to some embodiments of the disclosure.

FIG. 3B depicts a frame timing sequence according to an exemplary embodiment of the present disclosure.

FIG. 4 shows a flow chart of an example method for processing image data to correcting for movement in HDR image frame fusion according to some embodiments of the disclosure.

FIG. 5 is a block diagram illustrating an example processor configuration for image data processing in an image capture device according to one or more embodiments of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

In some aspects of the disclosure, temporal filtering (TF) may be applied or not applied to portions of an image frame based on motion detected within the image frame. The temporal filtering may be applied to remove distortions within image frames caused by movement of subjects while capturing image frames for composition into a single still image or as part of a video sequence. For example, the temporal filtering applied to regions of the image frame may reduce distortions caused from movement of one or more objects within an image frame that blur and/or blend together. In some aspects, the temporal filtering applied for correcting the image frame may be motion-compensated temporal filtering (MCTF). MCTF reduces noise and/or motion artifacts in video by filtering areas of motion based on global and/or local motion determinations for a current frame relative to a previous frame.

HDR processing may combine multiple image frames with different exposure times to generate an HDR image frame. However, movement of objects between or during these image frames (or previous HDR image frames) may cause distortions similar to those discussed above with TF processing. Motion maps for these image frames are often subject to inaccuracies caused by differing noise levels in the image frames being blended. In particular, image frames with shorter exposure times may have higher noise levels than image frames with longer exposure times. In such instances, the different noise levels may cause differences between the image frames that are interpreted as motion between the image frames. This may cause additional regions within the short exposure image frames to be unnecessarily blended within the final HDR image frame, increasing noise levels and reducing image quality. Reducing such errors requires adjusting a motion threshold for the HDR fusion process, which may be intractable in practice. In particular, if the motion threshold is too high, ghosting artifacts may be introduced because regions with actual motion are excluded. Furthermore, ideal motion threshold differ for different shooting conditions (such as at night, during the daytime, indoors, outdoors). It may thus not be feasible to use motion thresholds alone to properly identify regions of motion within separate image frames.

One solution to this problem may be to compute multiple motion maps based on different sets of image frames. Specifically, a first motion map may be determined based on a previous reference frame and a current image frame with a long exposure time. A second motion map may be determined based on a current image frame with a short exposure time and the current image frame with a long exposure time. The first and second motion maps may then be combined such that noise-induced motion regions within each motion map are cancelled out. For example, the first motion map may be subtracted from the second motion map to generate a third motion map. The current image frames may then be blended based on the third motion map to generate a fourth image frame (such as an HDR image frame for the current image frames). In certain instances, the improved, third motion map may also be used to apply a TF process and generate a fifth image frame to correct for motion between a previous reference-image frame and the fourth image frame.

Shortcomings mentioned here are only representative and are included to highlight problems that the inventors have identified with respect to existing devices and sought to improve upon. Aspects of devices described below may address some or all of the shortcomings as well as others known in the art. Aspects of the improved devices described herein may present other benefits than, and be used in other applications than, those described above.

An example device for capturing image frames using one or more image sensors, such as a smartphone, may include a configuration of one, two, three, four, or more cameras on a backside (e.g., a side opposite a primary user display) and/or a front side (e.g., a same side as a primary user display) of the device. The devices may include one or more image signal processors (ISPs), Computer Vision Processors (CVPs) (e.g., AI engines), or other suitable circuitry for processing images captured by the image sensors. The one or more image signal processors (ISP) may store output image frames in a memory and/or otherwise provide the output image frames to processing circuitry (such as through a bus). The processing circuitry may perform further processing, such as for encoding, storage, transmission, or other manipulation of the output image frames.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

In the description of embodiments herein, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Aspects of the present disclosure are applicable to any electronic device including, coupled to, or otherwise processing data from one, two, or more image sensors capable of capturing image frames (or “frames”). The terms “output image frame” and “corrected image frame” may refer to image frames that have been processed by any of the discussed techniques. Further, aspects of the present disclosure may be implemented in devices having or coupled to image sensors of the same or different capabilities and characteristics (such as resolution, shutter speed, sensor type, and so on). Further, aspects of the present disclosure may be implemented in devices for processing image frames, whether or not the device includes or is coupled to the image sensors, such as processing devices that may retrieve stored images for processing, including processing devices present in a cloud computing system.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU)) configured to perform the recited function through hardware, software, or a combination of hardware configured by software.

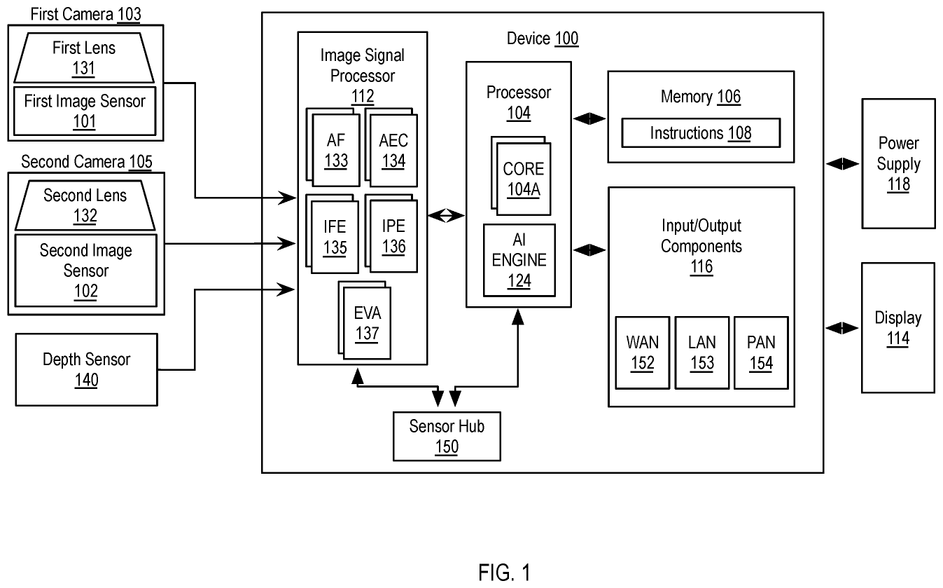

FIG. 1 shows a block diagram of an example device 100 for performing image capture from one or more image sensors. The device 100 may include, or otherwise be coupled to, an image signal processor 112 for processing image frames from one or more image sensors, such as a first image sensor 101, a second image sensor 102, and a depth sensor 140. In some implementations, the device 100 also includes or is coupled to a processor 104 and a memory 106 storing instructions 108. The device 100 may also include or be coupled to a display 114 and input/output (I/O) components 116. I/O components 116 may be used for interacting with a user, such as a touch screen interface and/or physical buttons.

I/O components 116 may also include network interfaces for communicating with other devices, including a wide area network (WAN) adaptor 152, a local area network (LAN) adaptor 153, and/or a personal area network (PAN) adaptor 154. An example WAN adaptor is a 4G LTE or a 5G NR wireless network adaptor. An example LAN adaptor 153 is an IEEE 802.11 WiFi wireless network adapter. An example PAN adaptor 154 is a Bluetooth wireless network adaptor. Each of the adaptors 152, 153, and/or 154 may be coupled to an antenna, including multiple antennas configured for primary and diversity reception and/or configured for receiving specific frequency bands.

The device 100 may further include or be coupled to a power supply 118 for the device 100, such as a battery or a component to couple the device 100 to an energy source. The device 100 may also include or be coupled to additional features or components that are not shown in FIG. 1. In one example, a wireless interface, which may include a number of transceivers and a baseband processor, may be coupled to or included in WAN adaptor 152 for a wireless communication device. In a further example, an analog front end (AFE) to convert analog image frame data to digital image frame data may be coupled between the image sensors 101 and 102 and the image signal processor 112.

The device may include or be coupled to a sensor hub 150 for interfacing with sensors to receive data regarding movement of the device 100, data regarding an environment around the device 100, and/or other non-camera sensor data. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and/or distance may be included in generated motion data. In some aspects, a gyroscope in an electronic image stabilization system (EIS) may be coupled to the sensor hub or coupled directly to the image signal processor 112. In another example, a non-camera sensor may be a global positioning system (GPS) receiver.

The image signal processor 112 may receive image data, such as used to form image frames. In one embodiment, a local bus connection couples the image signal processor 112 to image sensors 101 and 102 of a first camera 103 and second camera 105, respectively. In another embodiment, a wire interface couples the image signal processor 112 to an external image sensor. In a further embodiment, a wireless interface couples the image signal processor 112 to the image sensor 101, 102.

The first camera 103 may include the first image sensor 101 and a corresponding first lens 131. The second camera may include the second image sensor 102 and a corresponding second lens 132. Each of the lenses 131 and 132 may be controlled by an associated autofocus (AF) algorithm 133 executing in the ISP 112, which adjust the lenses 131 and 132 to focus on a particular focal plane at a certain scene depth from the image sensors 101 and 102. The AF algorithm 133 may be assisted by depth sensor 140.

The first image sensor 101 and the second image sensor 102 are configured to capture one or more image frames. Lenses 131 and 132 focus light at the image sensors 101 and 102, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging. The first lens 131 and second lens 132 may have different field of views to capture different representations of a scene. For example, the first lens 131 may be an ultra-wide (UW) lens and the second lens 132 may be a wide (W) lens. The multiple image sensors may include a combination of ultra-wide (high field-of-view (FOV)), wide, tele, and ultra-tele (low FOV) sensors.

That is, each image sensor may be configured through hardware configuration and/or software settings to obtain different, but overlapping, field of views. In one configuration, the image sensors are configured with different lenses with different magnification ratios that result in different fields of view. The sensors may be configured such that a UW sensor has a larger FOV than a W sensor, which has a larger FOV than a T sensor, which has a larger FOV than a UT sensor. For example, a sensor configured for wide FOV may capture fields of view in the range of 64-84 degrees, a sensor configured for ultra-side FOV may capture fields of view in the range of 100-140 degrees, a sensor configured for tele FOV may capture fields of view in the range of 10-30 degrees, and a sensor configured for ultra-tele FOV may capture fields of view in the range of 1-8 degrees.

The camera 103 may be a variable aperture (VA) camera in which the aperture can be controlled to a particular size. Example aperture sizes are f/2.0, f/2.8, f/3.2, f/8.0, etc. Larger aperture values correspond to smaller aperture sizes, and smaller aperture values correspond to larger aperture sizes. The camera 103 may have different characteristics based on the current aperture size, such as a different depth of focus (DOF) at different aperture sizes.

The image signal processor 112 processes image frames captured by the image sensors 101 and 102. While FIG. 1 illustrates the device 100 as including two image sensors 101 and 102 coupled to the image signal processor 112, any number (e.g., one, two, three, four, five, six, etc.) of image sensors may be coupled to the image signal processor 112. In some aspects, depth sensors such as depth sensor 140 may be coupled to the image signal processor 112, and output from the depth sensors are processed in a similar manner to that of image sensors 101 and 102. Example depth sensors include active sensors, including one or more of indirect Time of Flight (iToF), direct Time of Flight (dToF), light detection and ranging (Lidar), mmWave, radio detection and ranging (Radar), and/or hybrid depth sensors, such as structured light. In embodiments without a depth sensor 140, similar information regarding depth of objects or a depth map may be generated in a passive manner from the disparity between two image sensors (e.g., using depth-from-disparity or depth-from-stereo), phase detection auto-focus (PDAF) sensors, or the like. In addition, any number of additional image sensors or image signal processors may exist for the device 100.

In some embodiments, the image signal processor 112 may execute instructions from a memory, such as instructions 108 from the memory 106, instructions stored in a separate memory coupled to or included in the image signal processor 112, or instructions provided by the processor 104. In addition, or in the alternative, the image signal processor 112 may include specific hardware (such as one or more integrated circuits (ICs)) configured to perform one or more operations described in the present disclosure. For example, the image signal processor 112 may include one or more image front ends (IFEs) 135, one or more image post-processing engines 136 (IPEs), one or more auto exposure compensation (AEC) 134 engines, and/or one or more engines for video analytics (EVAs). The AF 133, AEC 134, IFE 135, IPE 136, and EVA 137 may each include application-specific circuitry, be embodied as software code executed by the ISP 112, and/or a combination of hardware and software code executing on the ISP 112.

In some implementations, the memory 106 may include a non-transient or non-transitory computer readable medium storing computer-executable instructions 108 to perform all or a portion of one or more operations described in this disclosure. In some implementations, the instructions 108 include a camera application (or other suitable application) to be executed by the device 100 for generating images or videos. The instructions 108 may also include other applications or programs executed by the device 100, such as an operating system and specific applications other than for image or video generation. Execution of the camera application, such as by the processor 104, may cause the device 100 to generate images using the image sensors 101 and 102 and the image signal processor 112. The memory 106 may also be accessed by the image signal processor 112 to store processed frames or may be accessed by the processor 104 to obtain the processed frames. In some embodiments, the device 100 does not include the memory 106. For example, the device 100 may be a circuit including the image signal processor 112, and the memory may be outside the device 100. The device 100 may be coupled to an external memory and configured to access the memory for writing output frames for display or long-term storage. In some embodiments, the device 100 is a system-on-chip (SoC) that incorporates the image signal processor 112, the processor 104, the sensor hub 150, the memory 106, and input/output components 116 into a single package.

In some embodiments, at least one of the image signal processor 112 or the processor 104 executes instructions to perform various operations described herein, including improved motion and noise correction operations for HDR fusion. For example, execution of the instructions can instruct the image signal processor 112 to begin or end capturing an image frame or a sequence of image frames, in which the capture includes motion and noise correction operations for HDR fusion as described in embodiments herein. In some embodiments, the processor 104 may include one or more general-purpose processor cores 104A capable of executing scripts or instructions of one or more software programs, such as instructions 108 stored within the memory 106. For example, the processor 104 may include one or more application processors configured to execute the camera application (or other suitable application for generating images or video) stored in the memory 106.

In executing the camera application, the processor 104 may be configured to instruct the image signal processor 112 to perform one or more operations with reference to the image sensors 101 or 102. For example, a camera application executing on processor 104 may receive a user command to begin a video preview display upon which a video comprising a sequence of image frames is captured and processed from one or more image sensors 101 or 102 through the image signal processor 112. Image processing to generate “output” or “corrected” image frames, such as according to techniques described herein, may be applied to one or more image frames in the sequence. Execution of instructions 108 outside of the camera application by the processor 104 may also cause the device 100 to perform any number of functions or operations. In some embodiments, the processor 104 may include ICs or other hardware (e.g., an artificial intelligence (AI) engine 124 or other co-processor) to offload certain tasks from the cores 104A. The AI engine 124 may be used to offload tasks related to, for example, face detection and/or object recognition. In some other embodiments, the device 100 does not include the processor 104, such as when all of the described functionality is configured in the image signal processor 112.

In some embodiments, the display 114 may include one or more suitable displays or screens allowing for user interaction and/or to present items to the user, such as a preview of the image frames being captured by the image sensors 101 and 102. In some embodiments, the display 114 is a touch-sensitive display. The I/O components 116 may be or include any suitable mechanism, interface, or device to receive input (such as commands) from the user and to provide output to the user through the display 114. For example, the I/O components 116 may include (but are not limited to) a graphical user interface (GUI), a keyboard, a mouse, a microphone, speakers, a squeezable bezel, one or more buttons (such as a power button), a slider, a switch, and so on.

While shown to be coupled to each other via the processor 104, components (such as the processor 104, the memory 106, the image signal processor 112, the display 114, and the I/O components 116) may be coupled to each another in other various arrangements, such as via one or more local buses, which are not shown for simplicity. While the image signal processor 112 is illustrated as separate from the processor 104, the image signal processor 112 may be a core of a processor 104 that is an application processor unit (APU), included in a system on chip (SoC), or otherwise included with the processor 104. While the device 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. As such, the present disclosure is not limited to a specific device or configuration of components, including the device 100.

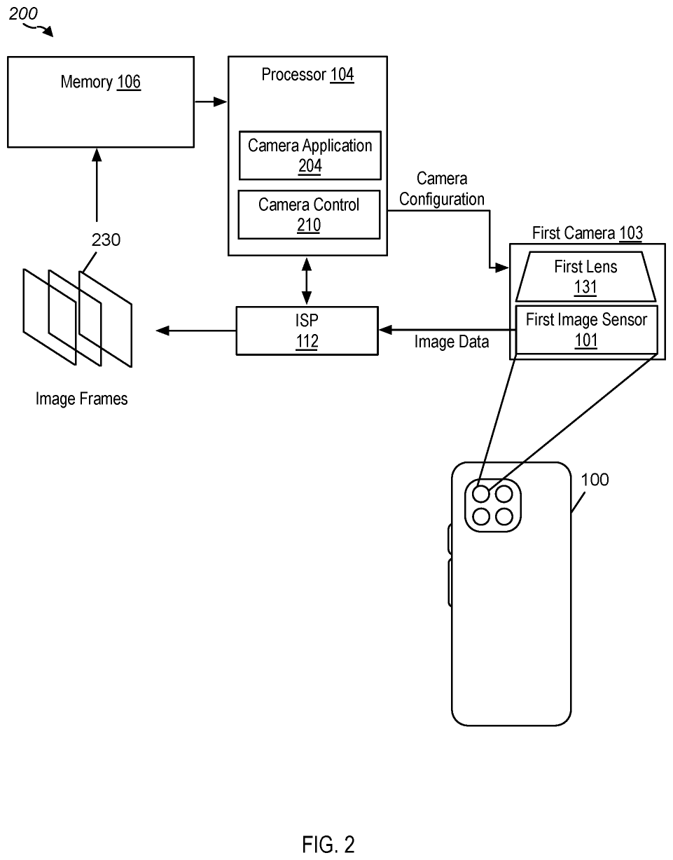

The exemplary image capture device of FIG. 1 may be operated to obtain improved images through improved motion detection and correction while combining multiple image frames to form HDR images or image frames. One example method of operating one or more cameras, such as camera 103, is shown in FIG. 2 and described below.

FIG. 2 is a block diagram illustrating an example data flow path for image data processing in an image capture device according to one or more embodiments of the disclosure. A processor 104 of system 200 may communicate with image signal processor (ISP) 112 through a bi-directional bus and/or separate control and data lines. The processor 104 may control camera 103 through camera control 210, such as for configuring the camera 103 through a driver executing on the processor 104. The camera control 210 may be managed by a camera application 204 executing on the processor 104, which provides settings accessible to a user such that a user can specify individual camera settings or select a profile with corresponding camera settings. The camera control 210 communicates with the camera 103 to configure the camera 103 in accordance with commands received from the camera application 204. The camera application 204 may be, for example, a photography application, a document scanning application, a messaging application, or other application that processes image data acquired from camera 103.

The camera configuration may parameters that specify, for example, a frame rate, an image resolution, a readout duration, an exposure level, an aspect ratio, an aperture size, etc. The camera 103 may obtain image data based on the camera configuration. For example, the processor 104 may execute a camera application 204 to instruct camera 103, through camera control 210, to set a first camera configuration for the camera 103, to obtain first image data from the camera 103 operating in the first camera configuration, to instruct camera 103 to set a second camera configuration for the camera 103, and to obtain second image data from the camera 103 operating in the second camera configuration.

In some embodiments in which camera 103 is a variable aperture (VA) camera system, the processor 104 may execute a camera application 204 to instruct camera 103 to configure to a first aperture size, obtain first image data from the camera 103, instruct camera 103 to configure to a second aperture size, and obtain second image data from the camera 103. The reconfiguration of the aperture and obtaining of the first and second image data may occur with little or no change in the scene captured at the first aperture size and the second aperture size. Example aperture sizes are f/2.0, f/2.8, f/3.2, f/8.0, etc. Larger aperture values correspond to smaller aperture sizes, and smaller aperture values correspond to larger aperture sizes. That is, f/2.0 is a larger aperture size than f/8.0.

The image data received from camera 103 may be processed in one or more blocks of the ISP 112 to form image frames 230 that are stored in memory 106 and/or provided to the processor 104. The processor 104 may further process the image data to apply effects to the image frames 230. Effects may include Bokeh, lighting, color casting, and/or high dynamic range (HDR) merging. In some embodiments, functionality may be embedded in a different component, such as the ISP 112, a DSP, an ASIC, or other custom logic circuit for performing the additional image processing.

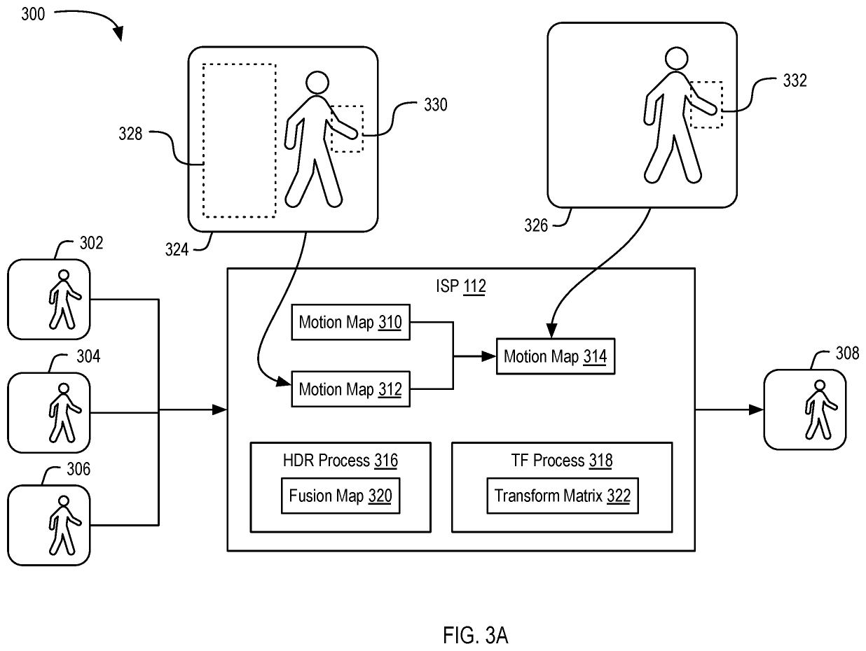

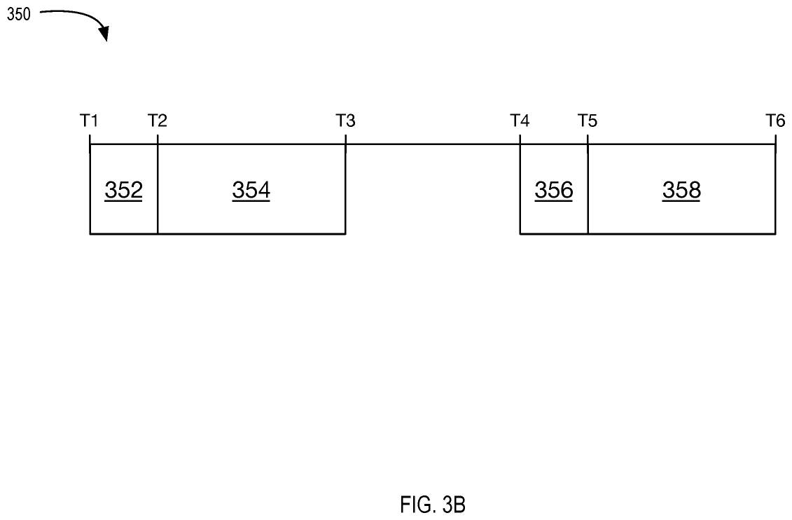

For example, FIG. 3A depicts a system 300 for correcting for movement in HDR image frame fusion according to some embodiments of the disclosure. The system 300 includes a first image frame 302, a second image frame 304, a third image frame 306, the ISP 112, and a fourth image frame 308. The ISP 112 includes a first motion map 310, a second motion map 312, a third motion map 314, an HDR process 316, and a temporal filtering (TF) process 318. The HDR process 316 includes a fusion map 320 and the TF process 318 includes a transform matrix 322.

The ISP 112 may be configured to receive a first image frame 302, a second image frame 304, and a third image frame 306. In particular, the ISP 112 may be configured to generate an output image frame, such as the fourth image frame 308, based on the image frames 302, 304, 306. In certain implementations, the first image frame 302 may be a reference frame, the second image frame 304 may be captured with a short exposure time, the third image frame 306 may be captured with a long exposure time, and combinations thereof. In certain implementations, the short exposure time may be less than 2 ms and the long exposure time may be greater than or equal to 2 ms. In certain implementations, the first image frame 302 may be captured before the second image frame 304 and the third image frame 306. For example, the second and third image frames 304, 306 may be current image frames (such as current image frames of an image processing pipeline for the image signal processor 112). The first image frame 302 may be a previous reference frame (such as a previous reference frame for an image processing pipeline of the ISP 112. In certain implementations, the second image frame 304 may be captured before the third image frame 306, or vice versa. In certain implementations, the first image frame 302 may be a reference frame for a previous image processing operation. For example, the first image frame 302 may be a reference frame for a TF process, such as the TF process 318. In certain implementations, the second image frame 304 may be processed by a spatial denoising process before further processing. In certain implementations, the third image frame 306 may be processed to correct for global movement (such as movement by an image capture device) between capturing the first image frame 302 and at least one of the second image frame 304 and the third image frame 306. In certain implementations, the image frames 302, 304, 306 may be captured by the same image sensor (such as the image sensor 101). In additional or alternative implementations, the image frames 302, 304, 306 may be captured by different image sensors (such as simultaneously or sequentially by two or more image sensors).

The ISP 112 may be configured to determine a first motion map 310 based on the first image frame 302 and the third image frame 306. The ISP 112 may also be configured to determine a second motion map 312 based on the second image frame 304 and the third image frame 306. The motion maps 310, 312 may be generated to indicate motion within one image frame relative to another. For example, the first motion map 310 may be generated to indicate motion within the third image frame 306 relative to the first image frame 302. As another example, the motion maps 312 may be generated to indicate motion within the third image frame 306 relative to the second image frame 304. In certain implementations, the motion maps 310, 312 may be computed based on differences between the image frames 302, 304, 306. For example, determining the first motion map 310 may include determining differences between the third image frame 306 and the first image frame 302. Similarly, determining the second motion map 312 may include determining differences between the second image frame 304 and the first image frame 302. In particular, local motion estimates may be determined by comparing the image frames 302, 304, 306. For example, the local motion estimates may be determined by comparing the locations of one or more objects within each of the image frames 302, 304, 306. The local motion estimates may be computed as differences between the image frames 302, 304, 306. As another example, local motion estimates may be calculated based on texture processing using Harris corner detection and related techniques. Local motion estimates and/or global motion estimates may then be combined to generate the motion maps 310, 312.

In additional or alternative implementation, the motion maps 310, 312 may be computed based on sensor data (such as motion sensor data, depth sensor data, or combinations thereof) from a device (such as the device 100) that captured the image frames 302, 304, 306. For example, the ISP 112 may be configured to compute one or more global motion estimates reflecting movement of the device and local motion estimates reflecting movement of one or more objects depicted within the image frames 302, 304, 306. In certain instances, the global motion estimates may be calculated based on sensor data, such as gyroscope or accelerometer data indicating movement of the image capture device. The global motion estimates may include one or both of a magnitude and direction of movement for the image capture device.

In certain implementations, the motion maps 310, 312 may be implemented separately from the corresponding image frames (e.g., as a separate data structure that corresponds to the corresponding image frames). In additional or alternative implementations, the motion maps 310, 312 may be implemented as a portion of the corresponding image frames (e.g., as a data layer or metadata layer of the corresponding image frames). For example, the first motion map 310 may be implemented as a metadata layer for the third image frame 306 and the motion maps 312 may be implemented as a metadata layer for the second image frame 304. Furthermore, the contents of the motion maps 310, 312 may correspond to particular portions of the corresponding image frames. For example, each pixel of the corresponding image frames may have a corresponding entry in the motion maps 310, 312. As another example, each entry in the motion maps 310, 312 may correspond to multiple pixels (e.g., 4 pixels, 9 pixels, 16 pixels, or more). The contents of the motion maps 310, 312 may indicate movement within corresponding portions of the corresponding image frames. For example, entries in the motion maps 310, 312 may indicate a magnitude of movement for an object or feature depicted within a corresponding portion of the corresponding image frames (e.g., relative to the first image frame 302 302). As one specific example, FIG. 3A includes an exemplary motion map 324, which may be computed as a motion map 312. The exemplary motion map 324 identifies regions 328, 330 in which motion may have occurred (such as in the third image frame relative to the first image frame. In various implementations, the magnitude of movement may be indicated as one or more of a number of pixels of movement, a distance of movement, a speed of movement, and the like. In certain implementations, the entries may also indicate a direction of movement.

In one specific implementation, the motion maps 310, 312 may be computed by the ISP 112 by comparing the corresponding image frames to generate an estimate of motion vectors between the image frames 302, 304, 306. The motion vectors and the sensor data may then be analyzed together to determine an alignment of the image capture device (e.g., to separate global motion of the image capture device from local motion of objects depicted within the image frames 302, 304, 306). The ISP 112 may then perform a matching process based on the alignment and the image frames 302, 304, 306 to generate the motion maps 310, 312. In certain implementations, the matching process may be performed as a semi-global matching (SGM) process.

The ISP 112 may be configured to determine a third motion map 314 based on the first motion map 310 and the second motion map 312. In certain implementations, the third motion map 314 may be determined to remove regions of high noise that are incorrectly identified as movement within the second motion map 312. For example, as noted above, noise value differences between an image frame 304 with a short exposure time and an image frame 306 with a longer exposure time may result in one or more regions of motion being detected incorrectly (such as where there is no motion). As a specific example, the exemplary motion map 324 contains the region 328, which is identified as containing motion but contains no actual movement of any objects depicted in the image frames 304, 306. The third motion map 314 may be determined to remove the region 328 from the motion map 324 and thus may only contain a region 332 corresponding to the correct region 330 within the exemplary motion map 324. In certain implementations, determining the third motion map 314 may include combining the first motion map 310 and the second motion map 312 (such as by subtracting the first motion map 310 from the second motion map 312). In certain implementations, the difference between corresponding values of the first motion map 310 and the second motion map 312 may be stored as movement values within the third motion map 314.

In certain implementations, correctly computing the third motion map 314 may require that image frames 304 with short exposure times are captured before image frames 306 with longer exposure times. For example, FIG. 3B depicts a frame timing sequence 350 according to an exemplary embodiment of the present disclosure. The frame timing sequence 350 includes frame timings 352, 354, 356, 358. The frame timings 352, 356 are shorter in duration and may represent exposure times for image frames captured with a short exposure time. The frame timings 354, 358 are longer in duration and may represent exposure times for image frames captures with a longer exposure time. In particular, a duration of the shorter frame timings 352, 356 (such as a time difference between T1 and T2 for the frame timing 352 and a time difference between T4 and T5 for the frame timing 354) may be less than 2 ms (such as 1 ms). A duration of the longer frame timings 354, 358 (such as a time difference between T2 and T3 for the frame timing 354 and a time difference between T5 and T6 for the frame timing 358) may be longer than 2 ms (such as 5 ms). In certain implementations, the time difference between sets of image frames (such as the time difference between T3 and T4) may be more than 5 ms (such as 33 ms), and may differ depending on the frame rate of video being captured. In certain implementations, image frames with long exposure times may be captured at the same time as image frames with short exposure times. For example, data for image frames with longer exposures may be captured during the frame times 352, 356 for image frames with shorter exposures. As a specific example, the frame times 352, 356 may be 1 ms long and the frame times 354, 358 may be 4 ms long, allowing for both a 1 ms exposure time for image frames with short exposures and a 5 ms exposure time for image frames with long exposures.

Notably, the frame timing sequence 350 includes frame times 352, 356 for short exposure image frames before the frame times 354, 358 for long exposure image frames. This may differ from the conventional frame timing of HDR-capable image sensors, which may typically capture long exposure image frames before short exposure image frames. Such frame timings may be necessary to properly determine the third motion map 314 such that the third motion map 314 removes noisy regions from the motion maps 312. For example, the third image frame 306 may typically have the lowest noise of the image frames 302, 304, 306 (such as when the first image frame 302 is a previous frame captured with a short exposure time). In such instances, generating both motion maps 310, 312 based on the third image frame 306 may ensure that both motion maps 310, 312 have similar noise levels, but that noise-induced movement regions in the motion maps 310, 312 are not correllated. Furthermore, the time differences between when the first image frame 302 is captured and the third image frame 306 is captures (such as the time difference from T1-T6) may ensure that local motion of objects within the image frames 302, 304, 306 is captured in both motion maps 310, 312. Specifically, movement that occurs between T4-T6 is captured in both the first motion map 310 (determined based on image frames 302, 306 captured from T1-T6) and the second motion map 312 (determined based on image frames 304, 306 captured from T4-T6). This may help ensure that, when subtracting the first motion map 310 from the second motion map 312, that motion is excluded from the third motion map 314 conservatively, reducing the likelihood that desired regions 330, 332 are removed from the third motion map 314, and may help reduce motion artifacts in regions of the image frames 304, 306 that are saturated with highlights due to increased motion coverage.

The ISP 112 may be configured to determine a fourth image frame 308 by combining the second image frame 304 and the third image frame 306. For example, the ISP 112 may combine the second image frame 304 and the third image frame 306 according to the third motion map 314. In certain implementations, the image frames 304, 306 may be combined to generate an HDR image frame. For example, the image frames 304, 306 may be combined according to an HDR process 316. The HDR process 316 may generate a fusion map 320 based on the third motion map 314. The fusion map 320 may include different weights to assign when blending the second image frame 304 with the third image frame 306 to generate the HDR image frame. The fusion map 320 may be generated based on various aspects of the image frames 304, 306 (such as brightness values, noise values, and the like) according to the HDR process 316. The HDR process 316 may further generate or update the fusion map 320 based on the third motion map 314. In particular, blending weights for the second image frame 304 may be increased within regions 332 of the third motion map 314 that indicate motion and may be decreased in portions of the third motion map 314 that do not indicate motion. The fourth image frame 308 may then be generated by applying the fusion map 320 to blend the second image frame 304 and the third image frame 306.

The ISP 112 may be further configured to determine a fifth image frame by applying a TF process 318 to correct for motion within the fourth image frame 308 based on the third motion map 314. In such instances, the fifth image frame may serve as the output image frame from the ISP 112. In certain implementations, the fifth image frame may be generated according to a TF process 318 (such as an MCTF process), which may receive the first image frame, 302, fourth image frame 308, the third motion map 314, or combinations thereof. In such instances, the TF process 318 may be used to generate a transform matrix 322 based on the third motion map 314. The ISP 112 may then apply the transform matrix 322 to the first image frame 302, the fourth image frame 308, or combinations thereof to generate the fifth image frame in certain implementations. In particular, the transform matrix 322 may be generated to correct for distortions or other errors caused by movement within the fourth image frame 308 relative to the first image frame 302. For example, the transform matrix 322 may be generated to indicate image transformations that should be applied to the first image frame 302 to correct for motion distortions within the fourth image frame 308. The transform matrix 322 may contain image transformations based on individual pixels within the fourth image frame 308 and/or one or more adjacent pixels within the image frame 308. Additionally or alternatively, the transform matrix 322 may include transformations based on other image frames (e.g., image frames 302 captured before the image frames 304, 306 and/or image frames captured after the image frames 304, 306), according to the TF process 318. In various implementations, the transform matrix 322 may contain the same or similar transformations for every pixel and/or portion of the image frame 302, 308. In additional or alternative implementations, the transform matrix 322 may indicate different transformations for different pixels and/or different portions of the image frame 302, 308.

In certain implementations, all or part of the above-described functionality may be implemented as one or more hardware blocks. For example, the ISP 112 may include an HDR hardware block, a TF processing hardware block, and combinations thereof, which may be configured to perform any of the above-described functionality. In still further implementations, all or part of the above-described functionality may be implemented as software configured to execute on a general purpose processor, such as the processor 104.

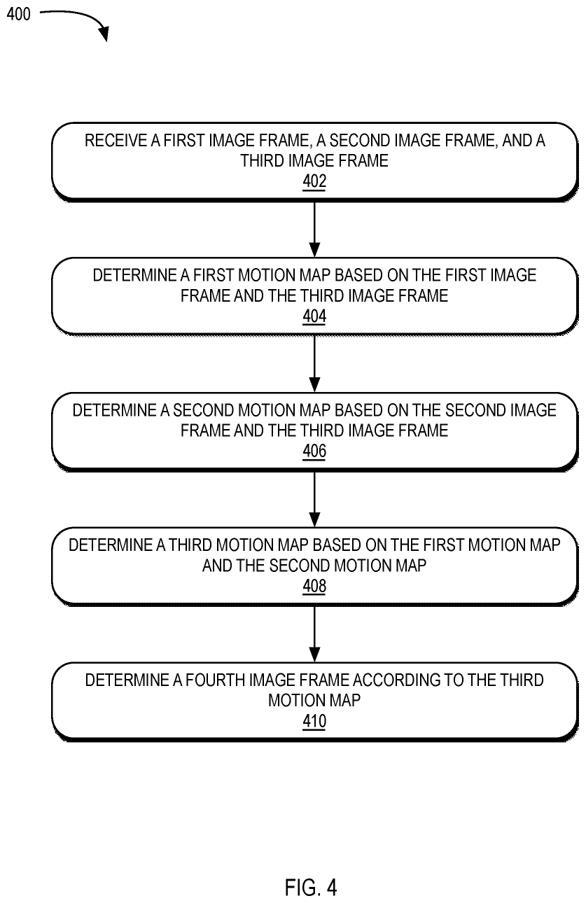

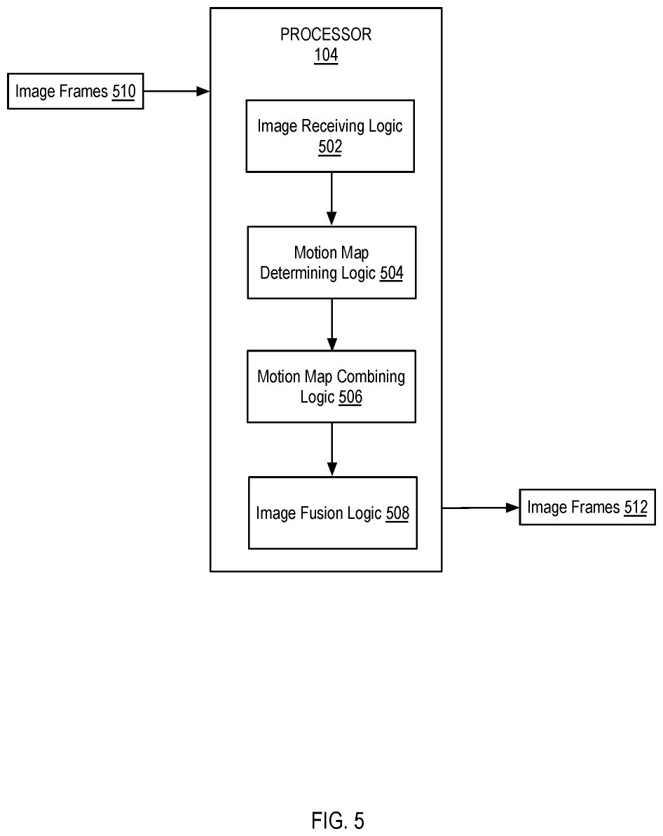

The systems 200, 300 may be configured to perform the operations described with reference to FIG. 5 to determine output image frames 230. FIG. 4 shows a flow chart of an example method 400 for processing image data to correct for movement in HDR image frame fusion according to some embodiments of the disclosure. The capturing in FIG. 5 may obtain an improved digital representation of a scene, which results in a photograph or video with higher image quality (IQ).

The method 400 includes receiving a first image frame, a second image frame, and a third image frame (block 402). For example, the ISP 112 may receive a first image frame 302, a second image frame 304, and a third image frame 306. As explained above, the first image frame 302 may be a reference frame, the second image frame 304 may be captured with a short exposure time, and the third image frame 306 may be captured with a long exposure time. The image frames 302, 304, 306 may be received at ISP 112, processed through an image front end (IFE) and/or an image post-processing engine (IPE) of the ISP 112, and stored in memory. In some embodiments, the capture of image frames 302, 304, 306 may be initiated by a camera application executing on the processor 104, which causes camera control 210 to activate capture of image frames 302, 304, 306 by the camera 103, and cause the image frames 302, 304, 306 to be supplied to a processor, such as processor 104 or ISP 112.

The method 400 includes determining a first motion map based on the first image frame and the third image frame (block 404). For example, the ISP 112 may determine a first motion map 310 based on the first image frame 302 and the third image frame 306. The method 400 also includes determining a second motion map 312 based on the second image frame 304 and the third image frame 306 (block 406). For example, the ISP 112 may determine a second motion map 312 based on the second image frame 304 and the third image frame 306. In certain implementations, the motion maps 310, 312 may be computed based on differences between the image frames 302, 304, 306. For example, determining the first motion map 310 may include determining differences between the third image frame 306 and the first image frame 302. Similarly, determining the second motion map 312 may include determining differences between the second image frame 304 and the first image frame 302. In particular, local motion estimates may be determined by comparing the image frames 302, 304, 306. Global motion estimates may also be determined, as explained above. Local motion estimates, global motion estimates, and combinations thereof may then be combined to generate the motion maps 310, 312.

The method 400 includes determining a third motion map based on the first motion map and the second motion map (block 408). For example, the ISP 112 may determine a third motion map 314 based on the first motion map 310 and the second motion map 312. In certain implementations, the third motion map 314 may be determined to remove regions of high noise that are incorrectly identified as movement within the second motion map 312. For example, image frames with short exposure times may be captured before image frames with long exposure times. In such instances, determining the third motion map 314 may include subtracting the first motion map 310 from the second motion map 312.

The method 400 includes determining a fourth image frame by combining the second image frame and the third image frame according to the third motion map (block 410). For example, the ISP 112 may determine a fourth image frame 308 by combining the second image frame 304 and the third image frame 306 according to the third motion map 314. In certain implementations, the second and third image frames 304, 306 may be combined according to an HDR process 316. In particular, a fusion map 320 of the HDR process 316 may be determined based at least in part on the third motion map 314 and the second image frame 304 may be combined with the third image frame 306 according to the fusion map 320. In certain implementations, as noted above, a fifth image frame may further be by applying a temporal filtering process to correct for motion within the fourth image frame 308 based on the third motion map 314 (such as according to a TF process 318). Output image frames may also be determined based on the fourth image frame 308, the fifth image frame, or combinations thereof. Image frames 230 may be determined by the processor 104 or ISP 112 and stored in memory 106. The stored image frames may be read by the processor 104 and used to form a preview display on a display of the device 100 and/or processed to form a photograph for storage in memory 106 and/or transmission to another device.

FIG. 5 is a block diagram illustrating an example processor configuration for image data processing in an image capture device according to one or more embodiments of the disclosure. The processor 104, or other processing circuitry, may be configured to operate on image data to perform one or more operations of the method of FIG. 4. The image data may be processed to determine one or more output image frames 512 based on one or more input image frames 510. The processor 104 includes image receiving logic 502, motion map determining logic 504, motion map combining logic 506, and image fusion logic 508.

The image receiving logic 502 may be configured to receive image frames 510. The image frames 510 may include a first image frame 302, a second image frame 304, and a third image frame 306. As explained above, the first image frame 302 may be a reference frame, the second image frame 304 may be captured with a short exposure time, and the third image frame 306 may be captured with a long exposure time.

The motion map determining logic 504 may be configured to determine a first motion map 310 based on the first image frame 302 and the third image frame 306 and to determine a second motion map 312 based on the second image frame 304 and the third image frame 306. In certain implementations, the motion maps 310, 312 may be computed based on differences between the image frames 510. For example, determining the first motion map 310 may include determining differences between the third image frame 306 and the first image frame 302. Similarly, determining the second motion map 312 may include determining differences between the second image frame 304 and the first image frame 302. In particular, local motion estimates may be determined by comparing the image frames 302, 304, 306. Global motion estimates may also be determined, as explained above. Local motion estimates, global motion estimates, and combinations thereof may then be combined to generate the motion maps 310, 312.

The motion map combining logic 506 may be configured to determine a third motion map 314 based on the first motion map 310 and the second motion map 312. In certain implementations, the third motion map 314 may be determined to remove regions of high noise that are incorrectly identified as movement within the second motion map 312, and may be determined to reduce motion artifacts in highlight saturation areas. For example, image frames with short exposure times may be captured before image frames with long exposure times. In such instances, determining the third motion map 314 may include subtracting the first motion map 310 from the second motion map 312.

The image fusion logic 508 may be configured to determine a fourth image frame 308 by combining the second image frame 304 and the third image frame 306 according to the third motion map 314. In certain implementations, the second and third image frames 304. 306 may be combined according to an HDR process 316. In particular, a fusion map 320 of the HDR process 316 may be determined based at least in part on the third motion map 314 and the second image frame 304 may be combined with the third image frame 306 according to the fusion map 320. In certain implementations, as noted above, a fifth image frame may further be by applying a temporal filtering process to correct for motion within the fourth image frame 308 based on the third motion map 314 (such as according to a TF process 318). Output image frames 512 may also be determined based on the fourth image frame 308, the fifth image frame, or combinations thereof. Image frames 512 may be determined by the image fusion logic 508 and stored in memory 106. The stored image frames 512 may be read by the processor 104 and used to form a preview display on a display of the device 100 and/or processed to form a photograph for storage in memory 106 and/or transmission to another device.

In one or more aspects, techniques for supporting image processing may include additional aspects, such as any single aspect or any combination of aspects described below or in connection with one or more other processes or devices described elsewhere herein. In a first aspect, the techniques described herein relate to an apparatus, including: a memory storing processor-readable code; and at least one processor coupled to the memory, the at least one processor configured to execute the processor-readable code to cause the at least one processor to perform operations including: receiving a first image frame, a second image frame, and a third image frame, wherein the second image frame is captured with a first exposure time and the third image frame is captured with a second exposure time longer than the first exposure time; determining a first motion map based on the first image frame and the third image frame; determining a second motion map based on the second image frame and the third image frame; determining a third motion map based on the first motion map and the second motion map; and determining a fourth image frame by combining the second image frame and the third image frame according to the third motion map.

Additionally, the apparatus may perform or operate according to one or more aspects as described below. In some implementations, the apparatus includes a wireless device, such as a UE. In some implementations, the apparatus includes a remote server, such as a cloud-based computing solution, which receives image data for processing to determine output image frames. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect according to the first aspect, wherein determining the fourth image frame includes: determining a fusion map for an HDR process based on the third motion map; and determining the fourth image frame by blending the second image frame and the third image frame according to the fusion map.

In a third aspect according to at least one of the first and second aspects the operations further include determining a fifth image frame by applying a temporal filtering process to correct for motion within the fourth image frame based on the third motion map.

In a fourth aspect according to the third aspect, the first image frame is a reference frame from a previous application of the temporal filtering process and has a third exposure time shorter than the second exposure time, and wherein the reference frame has been motion aligned and processed to reduce spatial noise.

In a fifth aspect according to at least one of the first through fourth aspects the first exposure time is less than 2 ms and the second exposure time is greater than or equal to 2 ms.

In a sixth aspect according to at least one of the first through fifth aspects the second image frame is captured before the third image frame.

In a seventh aspect according to at least one of the first through sixth aspects determining the third motion map includes combining the first motion map and the second motion map.

In an eighth aspect according to at least one of the first through seventh aspects determining the first motion map includes determining differences between the third image frame and the first image frame and wherein determining the second motion map includes determining differences between the second image frame and the first image frame.

In a ninth aspect, the techniques described herein relate to a method, including: receiving a first image frame, a second image frame, and a third image frame, wherein the second image frame is captured with a first exposure time and the third image frame is captured with a second exposure time longer than the first exposure time; determining a first motion map based on the first image frame and the third image frame; determining a second motion map based on the second image frame and the third image frame; determining a third motion map based on the first motion map and the second motion map; and determining a fourth image frame by combining the second image frame and the third image frame according to the third motion map.

In a tenth aspect according to the ninth aspect, determining the fourth image frame includes: determining a fusion map for an HDR process based on the third motion map; and determining the fourth image frame by blending the second image frame and the third image frame according to the fusion map.

In an eleventh aspect according to at least one of the ninth and tenth aspects, further including determining a fifth image frame by applying a temporal filtering process to correct for motion within the fourth image frame based on the third motion map.

In a twelfth aspect according to eleventh aspect, the first image frame is a reference frame from a previous application of the temporal filtering process and has a third exposure time shorter than the second exposure time and wherein the reference frame has been motion aligned and processed to reduce spatial noise.

In a thirteenth aspect according to at least one of the ninth through twelfth aspects, the first exposure time is less than 2 ms and the second exposure time is greater than or equal to 2 ms.

In a fourteenth aspect according to at least one of the ninth through thirteenth aspects, the second image frame is captured before the third image frame.

In a fifteenth aspect according to at least one of the ninth through fourteenth aspects, determining the third motion map includes combining the first motion map and the second motion map.

In a sixteenth aspect according to at least one of the ninth through fifteenth aspects, determining the first motion map includes determining differences between the third image frame and the first image frame and wherein determining the second motion map includes determining differences between the second image frame and the first image frame.

In a seventeenth aspect, the techniques described herein relate to a non-transitory, computer-readable medium storing instructions that, when executed by a processor, cause the processor to perform operations including: receiving a first image frame, a second image frame, and a third image frame, wherein the second image frame is captured with a first exposure time and the third image frame is captured with a second exposure time longer than the first exposure time; determining a first motion map based on the first image frame and the third image frame; determining a second motion map based on the second image frame and the third image frame; determining a third motion map based on the first motion map and the second motion map; and determining a fourth image frame by combining the second image frame and the third image frame according to the third motion map.

In an eighteenth aspect according to the seventeenth aspect, determining the fourth image frame includes: determining a fusion map for an HDR process based on the third motion map; and determining the fourth image frame by blending the second image frame and the third image frame according to the fusion map.

In a nineteenth aspect according to at least one of the seventeenth and eighteenth aspects, the operations further include determining a fifth image frame by applying a temporal filtering process to correct for motion within the fourth image frame based on the third motion map.

In a twentieth aspect according to the nineteenth aspect, the first image frame is a reference frame from a previous application of the temporal filtering process and has a third exposure time shorter than the second exposure time and wherein the reference frame has been motion aligned and processed to reduce spatial noise.

In a twenty-first aspect according to at least one of the seventeenth through twentieth aspects, the first exposure time is less than 2 ms and the second exposure time is greater than or equal to 2 ms.

In a twenty-second aspect according to at least one of the seventeenth through twenty-first aspects, the second image frame is captured before the third image frame.

In a twenty-third aspect according to at least one of the seventeenth through twenty-second aspects, determining the third motion map includes combining the first motion map and the second motion map.

In a twenty-fourth aspect, the techniques described herein relate to an image capture device, including: an image sensor; a memory storing processor-readable code; and at least one processor coupled to the memory and to the image sensor, the at least one processor configured to execute the processor-readable code to cause the at least one processor to: receive a first image frame, a second image frame, and a third image frame, wherein the second image frame is captured with a first exposure time and the third image frame is captured with a second exposure time longer than the first exposure time; determine a first motion map based on the first image frame and the third image frame; determine a second motion map based on the second image frame and the third image frame; determine a third motion map based on the first motion map and the second motion map; and determine a fourth image frame by combining the second image frame and the third image frame according to the third motion map.

In a twenty-fifth aspect according to the twenty-fourth aspect, determining the fourth image frame includes: determining a fusion map for an HDR process based on the third motion map; and determining the fourth image frame by blending the second image frame and the third image frame according to the fusion map.

In a twenty-sixth aspect according to at least one of the twenty-fourth and twenty-fifth aspects, the processor-readable code further causes the processor to determine a fifth image frame by applying a temporal filtering process to correct for motion within the fourth image frame based on the third motion map.

In a twenty-seventh aspect according to the twenty-sixth aspect, the first image frame is a reference frame from a previous application of the temporal filtering process and has a third exposure time shorter than the second exposure time and wherein the reference frame has been motion aligned and processed to reduce spatial noise.

In a twenty-eighth aspect according to at least one of the twenty-fourth through twenty-seventh aspects, the first exposure time is less than 2 ms and the second exposure time is greater than or equal to 2 ms.

In a twenty-ninth aspect according to at least one of the twenty-fourth through twenty-eighth aspects, the second image frame is captured before the third image frame.

In a thirtieth aspect according to at least one of the twenty-fourth through twenty-ninth aspects, determining the third motion map includes combining the first motion map and the second motion map.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-3 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIGS. 4 and 5 may be combined with one or more blocks (or operations) described with reference to another of the figures. For example, one or more blocks (or operations) of FIG. 4 may be combined with one or more blocks (or operations) of FIGS. 1-3. As another example, one or more blocks associated with FIG. 5 may be combined with one or more blocks (or operations) associated with FIGS. 1-3.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. An apparatus, comprising:
a memory storing processor-readable code; and
at least one processor coupled to the memory, the at least one processor configured to execute the processor-readable code to cause the at least one processor to perform operations including:
receiving a first image frame, a second image frame, and a third image frame, wherein the second image frame is captured with a first exposure time and the third image frame is captured with a second exposure time longer than the first exposure time;
determining a first motion map based on the first image frame and the third image frame;
determining a second motion map based on the second image frame and the third image frame;
determining a third motion map based on the first motion map and the second motion map; and
determining a fourth image frame by combining the second image frame and the third image frame according to the third motion map.

2. The apparatus of claim 1, wherein determining the fourth image frame comprises:
determining a fusion map for an HDR process based on the third motion map; and
determining the fourth image frame by blending the second image frame and the third image frame according to the fusion map.

3. The apparatus of claim 1, wherein the operations further comprise determining a fifth image frame by applying a temporal filtering process to correct for motion within the fourth image frame based on the third motion map.

4. The apparatus of claim 3, wherein the first image frame is a reference frame from a previous application of the temporal filtering process, and wherein the reference frame has been motion aligned and processed to reduce spatial noise.

5. The apparatus of claim 1, wherein the first exposure time is less than 2 ms and the second exposure time is greater than or equal to 2 ms.

6. The apparatus of claim 1, wherein the second image frame is captured before the third image frame.

7. The apparatus of claim 1, wherein determining the third motion map includes combining the first motion map and the second motion map.

8. The apparatus of claim 1, wherein determining the first motion map comprises determining differences between the third image frame and the first image frame and wherein determining the second motion map comprises determining differences between the second image frame and the first image frame.

9. A method, comprising:
receiving a first image frame, a second image frame, and a third image frame, wherein the second image frame is captured with a first exposure time and the third image frame is captured with a second exposure time longer than the first exposure time;
determining a first motion map based on the first image frame and the third image frame;
determining a second motion map based on the second image frame and the third image frame;
determining a third motion map based on the first motion map and the second motion map; and
determining a fourth image frame by combining the second image frame and the third image frame according to the third motion map.

10. The method of claim 9, wherein determining the fourth image frame comprises:
determining a fusion map for an HDR process based on the third motion map; and
determining the fourth image frame by blending the second image frame and the third image frame according to the fusion map.

11. The method of claim 9, further comprising determining a fifth image frame by applying a temporal filtering process to correct for motion within the fourth image frame based on the third motion map.

12. The method of claim 11, wherein the first image frame is a reference frame from a previous application of the temporal filtering process, and wherein the reference frame has been motion aligned and processed to reduce spatial noise.

13. The method of claim 9, wherein the first exposure time is less than 2 ms and the second exposure time is greater than or equal to 2 ms.

14. The method of claim 9, wherein the second image frame is captured before the third image frame.

15. The method of claim 9, wherein determining the third motion map includes combining the first motion map and the second motion map.

16. The method of claim 9, wherein determining the first motion map comprises determining differences between the third image frame and the first image frame and wherein determining the second motion map comprises determining differences between the second image frame and the first image frame.

17. A non-transitory, computer-readable medium storing instructions that, when executed by a processor, cause the processor to perform operations comprising:
receiving a first image frame, a second image frame, and a third image frame, wherein the second image frame is captured with a first exposure time and the third image frame is captured with a second exposure time longer than the first exposure time;
determining a first motion map based on the first image frame and the third image frame;
determining a second motion map based on the second image frame and the third image frame;
determining a third motion map based on the first motion map and the second motion map; and
determining a fourth image frame by combining the second image frame and the third image frame according to the third motion map.

18. The non-transitory, computer-readable medium of claim 17, wherein determining the fourth image frame comprises:
determining a fusion map for an HDR process based on the third motion map; and
determining the fourth image frame by blending the second image frame and the third image frame according to the fusion map.

19. The non-transitory, computer-readable medium of claim 17, wherein the operations further comprise determining a fifth image frame by applying a temporal filtering process to correct for motion within the fourth image frame based on the third motion map.

20. The non-transitory, computer-readable medium of claim 19, wherein the first image frame is a reference frame from a previous application of the temporal filtering process and has a third exposure time shorter than the second exposure time and wherein the reference frame has been motion aligned and processed to reduce spatial noise.

21. The non-transitory, computer-readable medium of claim 17, wherein the first exposure time is less than 2 ms and the second exposure time is greater than or equal to 2 ms.

22. The non-transitory, computer-readable medium of claim 17, wherein the second image frame is captured before the third image frame.

23. The non-transitory, computer-readable medium of claim 17, wherein determining the third motion map includes combining the first motion map and the second motion map.

24. An image capture device, comprising:
an image sensor;
a memory storing processor-readable code; and
at least one processor coupled to the memory and to the image sensor, the at least one processor configured to execute the processor-readable code to cause the at least one processor to:
receive a first image frame, a second image frame, and a third image frame, wherein the second image frame is captured with a first exposure time and the third image frame is captured with a second exposure time longer than the first exposure time;
determine a first motion map based on the first image frame and the third image frame;
determine a second motion map based on the second image frame and the third image frame;
determine a third motion map based on the first motion map and the second motion map; and
determine a fourth image frame by combining the second image frame and the third image frame according to the third motion map.

25. The image capture device of claim 24, wherein determining the fourth image frame comprises:
determining a fusion map for an HDR process based on the third motion map; and
determining the fourth image frame by blending the second image frame and the third image frame according to the fusion map.

26. The image capture device of claim 24, wherein the processor-readable code further causes the processor to determine a fifth image frame by applying a temporal filtering process to correct for motion within the fourth image frame based on the third motion map.

27. The image capture device of claim 26, wherein the first image frame is a reference frame from a previous application of the temporal filtering process, and wherein the reference frame has been motion aligned and processed to reduce spatial noise.

28. The image capture device of claim 24, wherein the first exposure time is less than 2 ms and the second exposure time is greater than or equal to 2 ms.

29. The image capture device of claim 24, wherein the second image frame is captured before the third image frame.

30. The image capture device of claim 24, wherein determining the third motion map includes combining the first motion map and the second motion map.
